(19) United States
(12) Patent Application Publication
(10) Pub. No.: US 2025/0214328 A1
(43) Pub. Date: Jul. 3, 2025

(54) DIRECTED THERMAL CONDUCTION ARTICLE, COMPOSITE AND METHOD

(71) Applicant: Nanyang Technological University, Singapore (SG)

(72) Inventors: Hortense Reine Marie-Marceline Le Ferrand, Singapore (SG); Hongying He, Singapore (SG)

(21) Appl. No.: 18/850,530

(22) PCT Filed: Apr. 14, 2023
(86) PCT No.: PCT/SG2023/050256

§ 371 Date: Sep. 24, 2024

(30) Foreign Application Priority Data
Apr. 19, 2022 (SG) 10202204046Y

(51) Int. Cl. B32B 27/20; B32B 27/08; B32B 27/30; B32B 37/24

(52) U.S. Cl. CPC B32B 27/20; B32B 27/08; B32B 27/30; B32B 37/24; B32B 2264/102; B32B 2264/107; B32B 2264/201; B32B 2264/401; B32B 2264/403; B32B 2264/502; B32B 2305/30; B32B 2307/206; B32B 2307/208; B32B 2307/302; B32B 2307/72; B32B 2311/30; B32B 2315/02; B32B 2329/00; B32B 2457/00

(57) ABSTRACT

An article including a composite. The composite includes a polymeric binder and particles in the polymeric binder, the particles being magnetically responsive and having a flake-like geometry. The particles include a thermally anisotropic material such that the particles are characterized by a higher in-plane thermal conductivity and a lower through-plane conductivity. The composite is characterized by at least one preferred thermal conduction path defined in sections of differently oriented alignments of the particles. At least two of the sections are differently oriented relative to one another by a gradient angular difference such that the at least two of the sections are non-parallel and non-perpendicular to one another. In specific embodiments, the particles are hexagonal boron nitride with superparamagnetic iron oxide nanoparticles adsorbed thereon, and the polymeric binder includes polyvinyl pyrrolidone.

### CROSS-REFERENCE TO RELATED APPLICATION

This application claims the benefit of priority to the Singapore Application No. 10202204046Y filed Apr. 19, 2022, which is hereby incorporated by reference in its entirety for all purposes.

### TECHNICAL FIELD

This application relates to articles, composite materials, and methods for thermal conduction.

### BACKGROUND

High-power-density electronic devices pose challenges in the field of thermal management, particularly as electronic devices tend toward increasingly higher packing densities.

### SUMMARY

In one aspect, the present application discloses an article, the article including a composite. The composite includes a polymeric binder and particles maintained together through the polymer binder, the particles being magnetically responsive and having a flake-like geometry. The particles include a thermally anisotropic material such that the particles are characterized by a higher in-plane thermal conductivity and a lower through-plane conductivity. The composite is characterized by at least one preferred thermal conduction path defined in sections of differently oriented alignments of the particles. At least two of the sections are differently oriented relative to one another by a gradient angular difference such that the at least two of the sections are non-parallel and non-perpendicular to one another.

In another aspect, the present application discloses a method of making the article. The method includes forming a plurality of layers on one another. Each of the plurality of layers is formed by: depositing a slurry as deposited materials, the slurry being an aqueous suspension of particles and polyvinyl pyrrolidone, the particles being hexagonal boron nitride flakes functionalized to be magnetically responsive; aligning the particles solely by providing a rotating external magnetic field to the deposited materials; and unaided drying of the deposited materials on a porous substrate under ambient conditions to form a composite of hexagonal boron nitride and polyvinyl pyrrolidone. The composite is characterized by at least one preferred thermal conduction path defined in sections of differently oriented alignments of the particles. Two of the sections are defined respectively in adjacent ones of the plurality of layers such the two of the sections are non-parallel and non-perpendicular to one another.

### BRIEF DESCRIPTION OF THE DRAWINGS

Various embodiments of the present disclosure are described below with reference to the following drawings:

FIG. 1A is a scanning electron micrograph image of an article made of a composite material according to one embodiment of the present disclosure;

FIG. 1B is a schematic diagram illustrating a magnified view of the composite material of FIG. 1A;

FIG. 2A and FIG. 2B are scanning electron micrograph images of crystalline hexagonal boron nitride (hBN) flakes;

FIG. 2C and FIG. 2D are scanning electron micrograph images of functionalized hBN flakes;

FIG. 2E is a schematic diagram of exemplary particles of microscale flakes decorated with magnetically responsive nanoparticles;

FIG. 3 is a schematic diagram of a gradient microstructure in an article or composite, according to one embodiment of the present disclosure;

FIG. 4 is a schematic diagram of a gradient microstructure in an article or composite, according to another embodiment of the present disclosure;

FIG. 5 is a schematic diagram of a gradient microstructure in an article or composite, according to yet another embodiment of the present disclosure;

FIGS. 6A to 6D are schematic diagrams illustrating a method of making the article or composite, according to one embodiment of the present disclosure;

FIGS. 7A to 7C are scanning electron micrograph images of composites made from slurry compositions with different concentrations of microscale two-dimensional (2D) particles;

FIGS. 8A to 8C are scanning electron micrograph images of differently oriented microstructures and their respective Fast Fourier Transform patterns;

FIG. 9 is a plot of thermal conductivity over a range of temperatures;

FIG. 10A is a series of infrared images recorded over a period of heating;

FIG. 10B is a series of infrared images recorded over a period of cooling;

FIG. 11 is a plot of electrical resistivity for differently oriented microstructures;

FIG. 12A shows plots of temperature of differently oriented microstructures over a period of heating and FIG. 12B is a schematic diagram showing an example of a gradient microstructure used;

FIG. 13A shows plots of temperature of differently oriented microstructures over a period of cooling and FIG. 13B is a schematic diagram showing an example of a gradient microstructure used;

FIG. 14A is a schematic diagram showing heat transfer relative to the microstructural configuration of a layered composite, in accordance with one embodiment of the present disclosure;

FIGS. 14B to 14E show a series of infrared images taken over time, showing the thermal distribution in the layered composite of FIG. 14A;

FIG. 15 is a schematic diagram of an exploded view of various components, without the article of the present disclosure; and

FIG. 16 is a schematic diagram of an exploded view of various components, showing an improved configuration that is made possible by the article/the composite of the present disclosure.

### DETAILED DESCRIPTION

The following detailed description is made with reference to the accompanying drawings, showing details and embodiments of the present disclosure for the purposes of illustration. Features that are described in the context of an embodiment may correspondingly be applicable to the same or similar features in the other embodiments, even if not explicitly described in these other embodiments. Additions and/or combinations and/or alternatives as described for a feature in the context of an embodiment may correspondingly be applicable to the same or similar feature in the other embodiments.

In the context of various embodiments, the articles “a”, “an” and “the” as used with regard to a feature or element include a reference to one or more of the features or elements.

In the context of various embodiments, the term “about” or “approximately” as applied to a numeric value encompasses the exact value and a reasonable variance as generally understood in the relevant technical field, e.g., within 10% of the specified value.

As used herein, the term “and/or” includes any and all combinations of one or more of the associated listed items.

As used herein, “comprising” means including, but not limited to, whatever follows the word “comprising”. Thus, use of the term “comprising” indicates that the listed elements are required or mandatory, but that other elements are optional and may or may not be present.

As used herein, “consisting of” means including, and limited to, whatever follows the phrase “consisting of”. Thus, use of the phrase “consisting of” indicates that the listed elements are required or mandatory, and that no other elements may be present.

Terms such as “first” and “second” are used in the description and claims only for the sake of brevity and clarity, and do not necessarily imply a priority or order, unless specified.

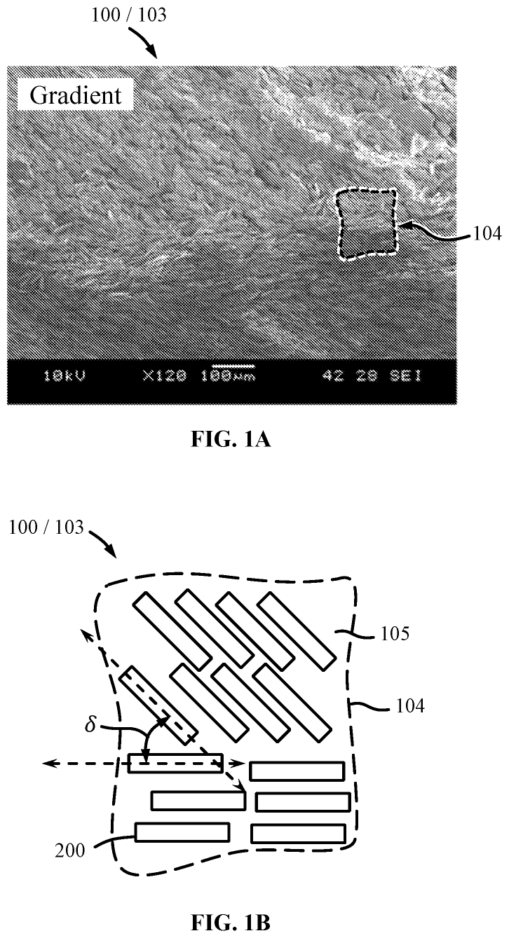

FIG. 1A is a scanning electron micrograph image of an article 100 with a composite material 103 according to one embodiment of the present disclosure. As can be seen, particles of microscale (with the particles' largest linear dimensions under 100 micrometers) are aligned in generally the same direction in one region, while neighboring regions may have differently oriented particles. Preferably, the composite is formed with particles generally characterized by a largest linear dimension in a range of about 2 micrometers to 100 micrometers. For the sake of brevity, the term “particle orientation” is used in the present disclosure to refer to the generally similar orientation of the particles in the same region. In the same article, there are at least two immediately adjacent regions defining a gradient between their respective particle orientations. As used in the present disclosure, the term “gradient” refers to a relative difference between two particle orientations that is greater than zero and less than 90 degrees. In other words, two particle orientations form a “gradient” if the two particle orientations are neither parallel nor perpendicular relative to one another. One article 100 may combine two or more particle orientations to form a complex orientation configuration.

FIG. 1B is a schematic diagram illustrating a magnified cross-sectional view 104 of the composite material 103 forming at least a part of the article 100 of FIG. 1A. The article 100 includes the composite 103, in which the composite 103 includes a polymer binder 105 and particles 200 distributed therein. The particles 200 are preferably selected from microscale particulate materials in which the individual particles are each characterized by anisotropic thermal properties. As used herein, the term “particle” refers to microscale particles with a substantially flat geometry or profile, which for the sake of brevity may be described in terms of having a flake-like geometry. As used herein, the term “particle” may be interchangeable with terms such as but not limited to platelets, two-dimensional (2D) particles, flakes, or plate-like particles. Preferably, the particles 200 are also magnetically responsive. Preferably, the particles 200 are electrically insulative and magnetically responsive microscale flakes with a relatively high thermal conductivity in-plane and a relatively low thermal conductivity through-plane. The article 100 includes particles 200 that exhibit a gradient δ between respective planes of neighboring ones of the particles 200.

As used herein, the terms “gradient”, “gradient change”, “gradient difference”, “gradient angle”, “gradient angular difference”, “gradual angular change”, “gradual inclination”, etc., may be interchangeably used to refer to a non-zero angular displacement, difference, or change, that is smaller than 90 degrees. As used herein in the context of angles, the terms “gradient”, “gradual”, and “acute” are interchangeable and may be understood to similarly describe an angle that is less than 90 degrees.

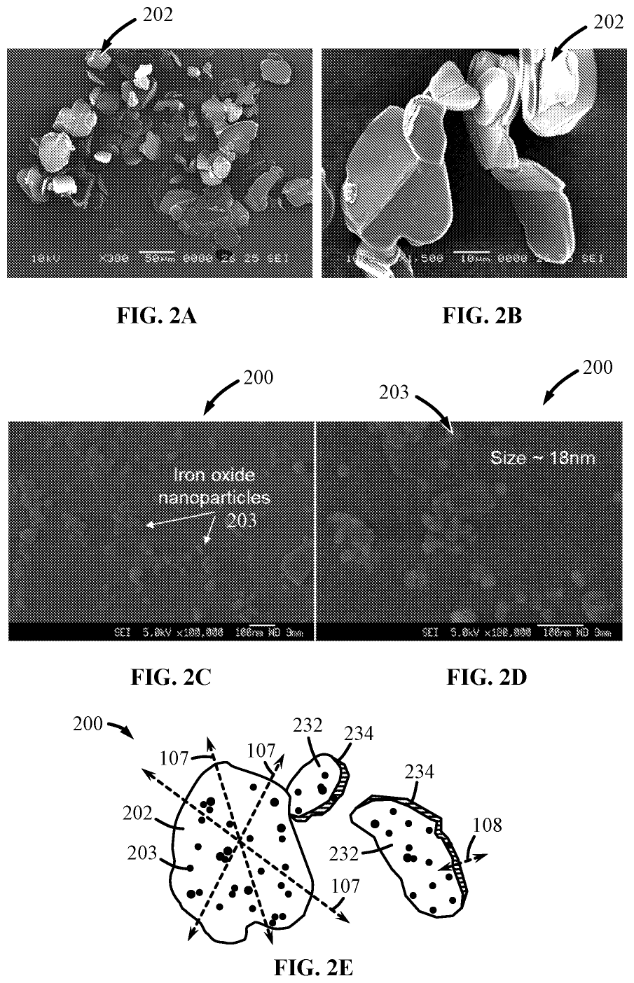

Examples of particles 200 include but are not limited to ceramic particles, such as but not limited to aluminum oxide, glass, mica, graphite, crystalline hexagonal boron nitride (hBN), etc. The polymeric binder includes but is not limited to polyvinyl pyrrolidone, polyvinyl alcohol, polymethyl methacrylate, etc. The binder is selected so that upon unaided drying, the resulting composite (including the particles and the binder) is characterized by a degree of porosity, i.e., the composite is not a polymeric matrix with the particles wholly embedded in the matrix. For the sake of brevity, the following description will refer to boron nitride particles. FIG. 2A and FIG. 2B are scanning electron micrographs of different magnifications, showing exemplary crystalline hBN 2D micropowder 202. FIG. 2C and FIG. 2D are scanning electron micrographs showing exemplary particles 200 formed by functionalizing the hBN flakes 202 of FIGS. 2A and 2B with iron oxide nanoparticles 203. When a magnet is placed to one side of a container containing a suspension of the particles 200 of FIGS. 2C and 2D in ethanol or other aqueous solution, the particles 200 may be observed to be attracted to the side of the container with the magnet, verifying the magnetic properties of the particles 200.

To aid understanding, a few particles 200 are schematically illustrated in FIG. 2E. The particles 200 include microscale flakes 202 decorated with magnetic nanoparticles 203. The flakes 202 may be of various shapes and sizes and need not be strictly flat. Preferably, the particles 200 are generally planar or 2D (two-dimensional), i.e., with two substantially opposing major surfaces 232 and relatively thin thickness 234 therebetween. Each particle 200 is characterized by anisotropic thermal properties, i.e., each particle 200 includes a thermally anisotropic material such that the particles are characterized by a higher in-plane thermal conductivity and a lower through-plane thermal conductivity. For example, each particle 200 may be characterized by an in-plane thermal conductivity along various in-plane directions 107 of the particle 200 that differs from a through-plane thermal conductivity along a through-plane direction 108.

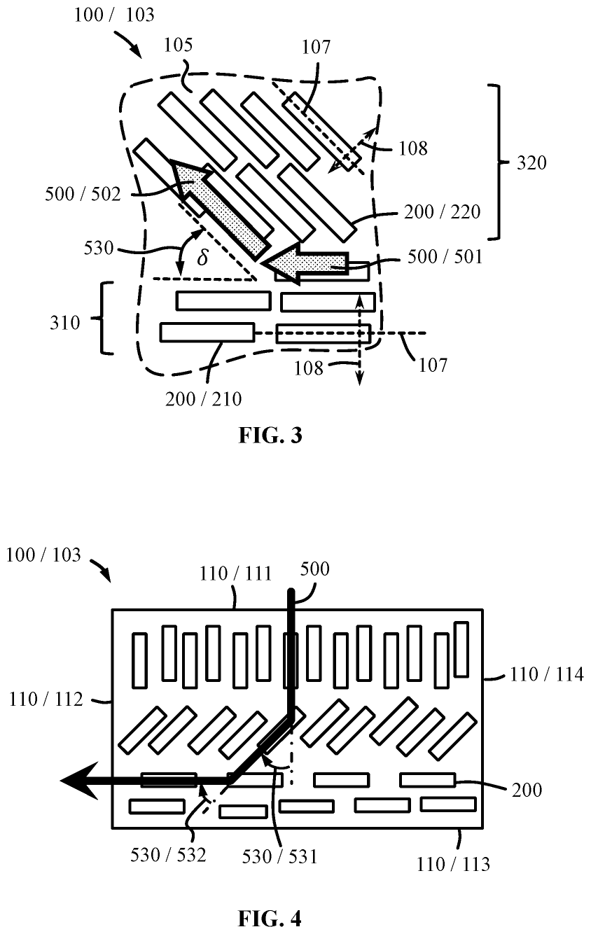

Referring to the schematic diagram of FIG. 3, the article 100 includes a first region 310 in which a first plurality of particles 210 are generally packed and aligned with their respective planes or in-plane directions 107 being substantially parallel to one another. The article 100 includes a second region 320 in which a second plurality of particles 220 are generally packed and aligned with their respective planes or in-plane directions 107 being substantially parallel to one another. In other words, within one region, the plurality of particles 200 are generally packed with their respective through-plane directions 108 generally parallel. Between different regions, through-plane directions 108 of the particles 200 differ by a gradient angular difference. The preferred thermal conduction path 500 is defined to at least partially traverse the first region 310 and the second region 320. The preferred thermal conduction path 500 includes at least one gradient change 8 in direction as the preferred thermal conduction path 500 crosses between regions. That is, the article 100 or the composite 103 is configured with at least one preferred thermal conduction path 500 that can be defined in various sections 501/502 in the composite 103 by differently oriented alignments of the particles 200 distributed in a binder 105. The thermal conduction path 500 is made up of at least two successive sections 501/502 in which the sections are differently oriented relative to one another. The thermal conduction path 500 is made of at least two sections, in which one of the at least two sections defines a gradient angular different or a gradient δ relative to another of the at least two sections. Successive sections 501/502 are preferably defined such that they are non-parallel and non-perpendicular to one another. In the presence of a temperature difference, the corresponding heat flux is gradually angularly displaced along the path of preferred thermal conduction 500. In other words, the preferred thermal conduction path provided by the proposed article 100/proposed composite 103 may be described as being multi-directional. In contrast, the conventional thermal conduction path across a material (e.g., thermal interface materials) is uni-directional and always in a straight line between opposing surfaces.

Immediately adjacent regions of the article 100 are characterized by respective through-plane directions 108 that are neither parallel nor perpendicular to one another. The article 100 is characterized by a gradual change in thermal anisotropy corresponding to the gradient 530 between immediately adjacent regions 310, 320. The gradient 530 or the orientation difference δ shown in FIG. 1 is about 45 degrees, but it will be understood that the example of FIG. 1 is merely an illustrative and not limiting. The article 100 may be configured with other gradients 530.

The behavior of heat flux in the present article 100 is contrary to what is conventionally understood of heat transfer occurring in a generally straight line from one surface 110 to an opposing surface 110 of a mass. In experiments/simulations, a heat source (not shown) is provided at a first surface 111 of the article 100 such that there is a temperature gradient between the first surface 111 and each of the second surface 112, the third surface 113, and the fourth surface 114. As illustrated in the schematic diagram of FIG. 4, at least one preferred thermal conduction path 500 in the article 100 or the composite 103 is configured to bend through at least two acute angles (gradient changes 531, 532) when changing from first direction to a second direction that is perpendicular to the first direction. In this example, the heat flux follows the preferred thermal conduction path leading to a non-opposing surface. In other words, the article 100 is capable of providing directed thermal conduction. The article 100 may be described as a directed thermal conduction article.

Conventionally, rod-shaped microscale or nanoscale particles (e.g., carbon nanotubes) are preferred as the geometry of the nanotubes provide a natural path for directing the heat flux along the length of the nanotubes and along the direction of higher thermal conductivity. In the case of the hBN flake, it is characterized by an in-plane thermal conductivity K_{∥} of about 400 Wm⁻¹K⁻¹ and a lower through-plane thermal conductivity of 30 Wm⁻¹K⁻¹. A 2D flake shape has a relatively high aspect ratio (lateral size/thickness) and facilitates anisotropic thermal conductivity. However, it can be appreciated that the geometry of a flake places certain challenges to exploiting the anisotropic thermal conductivity. Owing to the geometry of a hBN flake, It is believed that in the presence of a temperature gradient across a particle 200, the resultant thermal flux is somewhat in a through-plane direction and off-set from the through-plane direction 108. Yet, the article 100 of the present disclosure can be configured with unconventionally shaped preferred thermal conduction paths 500, e.g., the article 100 can provide a preferred thermal conduction path that deviates from the conventional straight thermal conduction path, and also take advantage of the significantly higher thermal conductivity along in-plane directions of the particles 200.

FIG. 5 schematically illustrates the article 100 according to another embodiment of the present disclosure. The article 100 includes particles 200 distributed in a plurality of regions 310, 320, 330, 340, 350. The particles 200 are generally in alignment within the same region. The preferred thermal conduction paths 500 are configured to undergo a few gradient changes such that an axially oriented heat flux can be re-oriented into a transversely oriented heat flux. This example of the article 100 is configured to favor thermal conduction from both opposing surfaces 111 to a non-opposing surface 112. New types of thermal management products can be made possible by this ability to “bend” the preferred thermal conduction path.

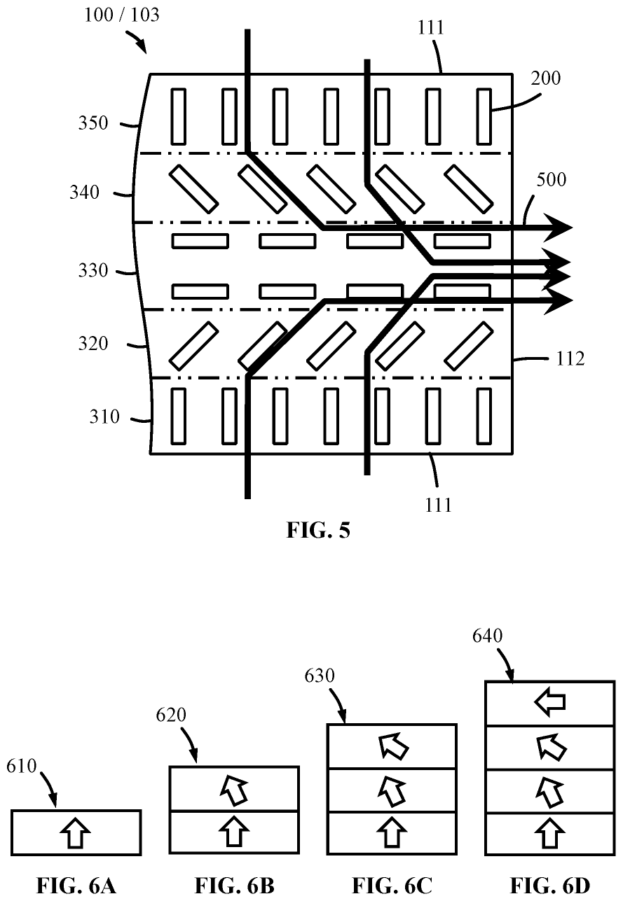

In the example of FIG. 5, the article 100 or the composite 103 includes a plurality of layers, each corresponding to region 310/320/330/340/350. In other words, the article 100 is advantageously suitable for fabrication layer-by-layer. As illustrated schematically in FIG. 6A to FIG. 6D, the present disclosure provides a non-limiting exemplary method of making the article 100 with at least two layers, in which successive ones of the at least two layers have differently oriented thermal anisotropic properties or differently oriented macroscopic thermal conductivity. For example, the present method may include forming a first layer 610 with a first orientation of highest thermal conductivity (FIG. 6A), followed by forming a second layer 620 with a second orientation of highest thermal conductivity (FIG. 6B), followed by forming a third layer 630 with a third orientation of highest thermal conductivity (FIG. 6C), and followed by forming a fourth layer 640 with a fourth orientation of highest thermal conductivity (FIG. 6D). Other examples may include forming different numbers of layers and/or partial layers. In this example, the angular displacement between the orientations of the highest thermal conductivity of the first layer 610 and the final layer 640 is about 90 degrees. The angular displacement between any two successive layers (such as between the first layer 610 and the second layer 620, between the second layer 620 and the third layer 630, and between the third layer 630 and the fourth layer 640) is a gradient change such that accumulatively the angular displacement between the first layer 610 and the final layer (in this case the fourth layer) 640 is about 90 degrees. The one or more layers 620,630 disposed between the first layer 610 and the final layer 640 may be referred to as intermediate layers.

### Experimental Results

### Functionalization

Various polymer-and-hBN composite samples according to embodiments of the present disclosure were tested. One advantage of the proposed method is its scalability for large scale industrial processes as it can advantageously work with commercially available hBN sheets. It is not necessary to use exfoliation to obtain nanosheets from bulk boron nitride powder and the proposed method is therefore not limited to the laboratory.

Hexagonal boron nitride (hBN) nanosheets stacked into hBN crystalline 2D micropowder with a thickness of about 1070 nm (nanometer) and about 45 μm (micrometer) lateral dimensions were functionalized using superparamagnetic iron oxide nanoparticles 203 (FIG. 2C) of about 10 nm to 20 nm diameter to form an aqueous suspension. The nanoparticles 203 have positive surface charges allowing their physical adsorption at the surface 232 (FIG. 2E) of the negatively charged hBN 2D micropowder through electrostatic interactions when suspended in water. After the adsorption of the nanoparticles at the surface of the hBN 2D micropowder, which takes place over a period of approximately five days, the functionalized hBN are filtered out and rinsed with water and ethanol, before being thoroughly dried. The amount of surface functionalization can be tailored according to the magnetic field strength applied during magnetically assisted slip casting. For example, more nanoparticles are preferably added at this step if there are constraints on the magnetic field strength applicable in a later step (magnetically assisted slip casting). The functionalized hBN 2D microparticles are then used as filler particles for the composite preparation. The functionalized hBN 2D micropowder/particles show a strong magnetic response to external magnetic fields. That is, it was experimentally verified that functionalized hBN 2D micropowder/particles are sufficiently magnetically responsive. Other materials may be used, i.e., the composite is not limited to polyvinyl pyrrolidone (PVP) with hBN particles.

### Slurry Composition and Magnetically Assisted Slip Casting

Slurry compositions were prepared using a mixture of the functionalized 2D particles, water as a solvent, and 5 wt % polyvinyl pyrrolidone as a binder. The slurry was used in a magnetically assisted slip casting process. Samples of the composite 103 were fabricated in one or more layers using magnetically assisted slip casting. The method of forming a layer involves depositing a slurry in a porous mold or on a previously formed layer in the mold. Simultaneously, a rotating external magnetic field is applied to the deposited materials. While the magnetically responsive particles in the deposited slurry are being aligned in generally the same direction by the rotating external magnetic field, the deposited material is also concurrently undergoing a drying or evaporation process. The filler particle concentration in the slurry and the binder material are selected such that post-alignment high temperature curing is not required to align the filler particles in a desired orientation using a low magnetic field, or to fix the filler particles in the desired orientation under ambient conditions. When the deposited material has dried, the remaining product is a composite of particles aligned in a desired orientation, e.g., a composite of BN flakes as fillers in a polyvinyl pyrrolidone (PVP) binder. Upper layers can be formed without disturbing the previously formed lower layers. Overall, the magnetically assisted slip casting and alignment method is faster and less resource consuming than conventional step-by-step stereolithography methods. According to the present method, there is no need to subject the deposited material to an additional vibration step. It has been experimentally verified that, using the present method (no vibration step involved), a slurry of 40 wt % hBN flakes can form a composite of 62.6 vol % hBN in which the hBN flakes are packed in alignment with one another.

In one experiment, the magnetically assisted slip casting was carried out by pouring the aqueous suspension onto a porous mold made of gypsum. A rotating external magnetic field was applied to the deposited materials. After casting, water was removed and the composite was dried in the mold overnight before the composite was removed from the mold. In the present method, the drying (removal of water) and the alignment of the hBN flakes substantially occur simultaneously. In other words, there is no post-alignment step of polymerization or curing. The composite may be casted in various dimensions with thicknesses ranging from about 100 μm to a few millimeters, without specific limitation to the lateral size or shape. It was observed that the shape of the mold did not affect the quality of the resulting orientation of the particles.

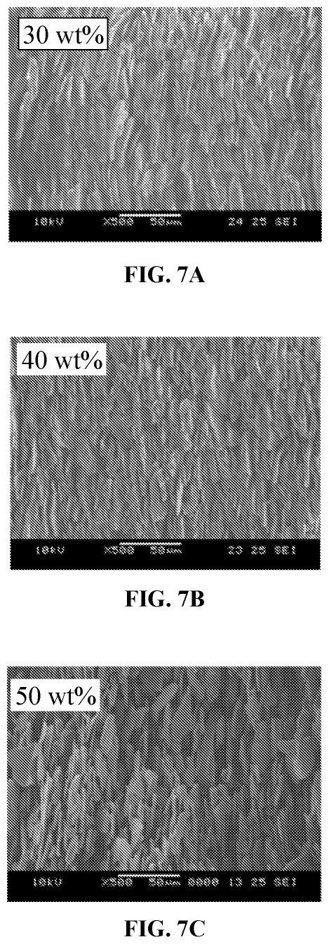

Experiments were carried out using different slurry compositions in attempts to form composites in which the functionalized 2D particles (flakes) were “vertically” aligned or axially aligned, i.e., with the plane of the particles substantially perpendicular to a substrate. FIGS. 7A to 7C are scanning electron micrograph images of the resulting composite made from slurry compositions of 30 wt % (FIG. 7A), 40% wt % (FIG. 7B), and 50 wt % (FIG. 7C) of the functionalized hBN 2D particles, respectively. It was found that if the concentration of hBN flakes in the slurry was too low or too high, after removal of the water through the pores of the mold, the hBN flakes appeared in a “horizontal” or transverse orientation relative to the substrate or in generally random orientation, instead of the intended “vertical” or axial alignment. The experiments showed that, preferably, the slurry composition includes 40 wt % functionalized hBN 2D particles, water as solvent, and 5 wt % PVP as a binder. A surfactant such as the ammonium salt of polymethacrylic acid (commercially available as Dolapix CE 64) may be used.

### Orientation Control

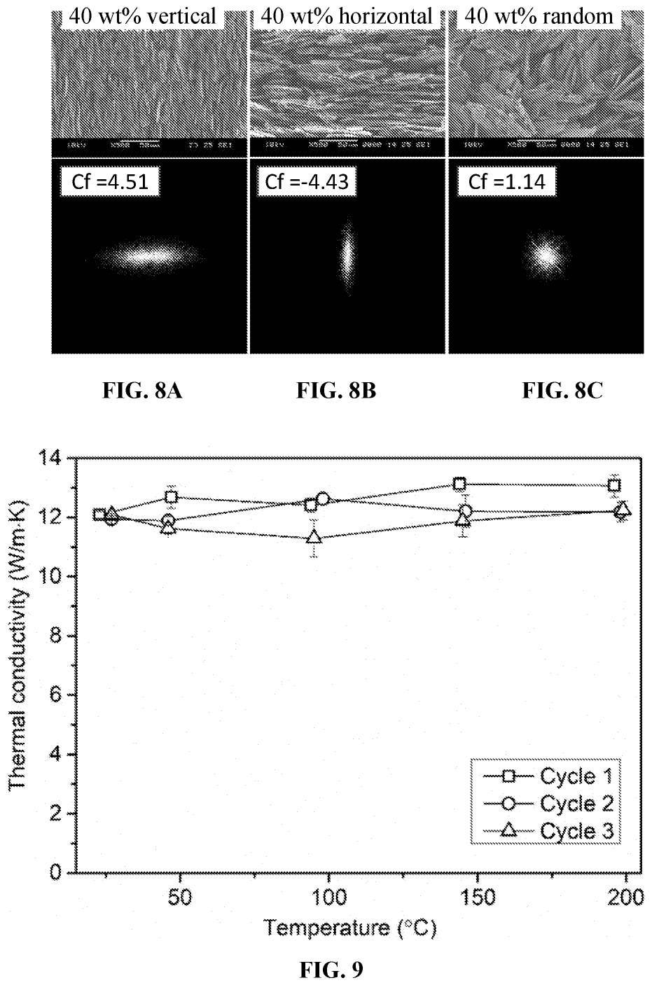

The orientation of the hBN 2D particles was solely controlled by the rotating external magnetic field applied during magnetically assisted slip casting. Using 40 wt % slurry composition, differently oriented external magnetic fields were applied to obtain samples (upper row of images in FIGS. 8A to 8C) of the composite in which the hBN particles were differently oriented. The orientation can be measured by taking the Fast Fourier Transform (FFT) of the electron micrographs of the cross-section of the composite and measuring the ratio of the long-axis FWHM (full-width-at-half-maximum) value to the short-axis FWHM value of the Gaussian fitted curves from the FFT pattern. The value obtained is referred to as the conformation factor CF (lower row of images in FIGS. 8A to 8C). The higher CF value represents the better alignment in the composite. The CF value for the “vertical” or axial alignment was the highest among the various different alignment orientations in the experiments.

### Composite Performance

The composites obtained displayed a low density of 1.3 g/cm³. The thermal conductivity along an alignment orientation of the hBN 2D microparticles is higher than that of other compositions. The thermal conductivity of the article 100 or the composite 103 were measured and found to be about 12 W/mK along the alignment direction over a range of temperature from 25° C. to 200° C. (FIG. 9).

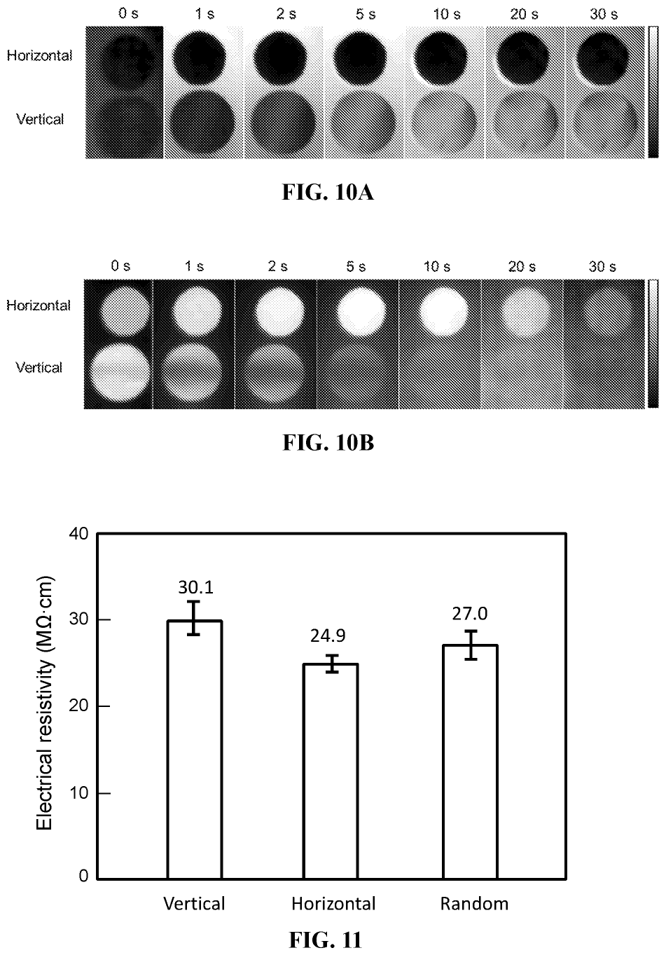

FIG. 10A shows a series of infrared images recorded over a period of time when a sample of the composite 103 was subjected to during heating. The upper row shows the images of a top surface of a sample in which the hBN flakes were “horizontally” or transversely aligned. The lower row shows the images of a top surface of a sample in which the hBN flakes were “vertically” or axially aligned. FIG. 10B shows a series of infrared images recorded over a period of time when a sample of the composite 103 was subject to cooling. The upper row shows the images of a top surface of a sample in which the hBN flakes were “horizontally” or transversely aligned. The lower row shows the images of a top surface of a sample in which the hBN flakes were “vertically” or axially aligned. In FIGS. 10A and 10B, the whiter color (or a lighter shade) indicates a higher temperature, and the black color (or a darker shade) indicates a lower temperature.

The higher thermal conductivity of the vertically or axially oriented samples (as compared to the horizontally or transversely oriented samples) leads to their faster heating and cooling (FIGS. 10A, 10B). Comparing these sets of infrared images, it can be appreciated that the composites 103 of the present disclosure can harness the anisotropic thermal characteristics of the individual hBN flakes at a macroscopic or article level to provide directed or directional thermal conduction. The composite also exhibit good electrical insulating properties (FIG. 11) such that it can be used in many electronic packaging applications.

### Gradient or Graded Microstructures

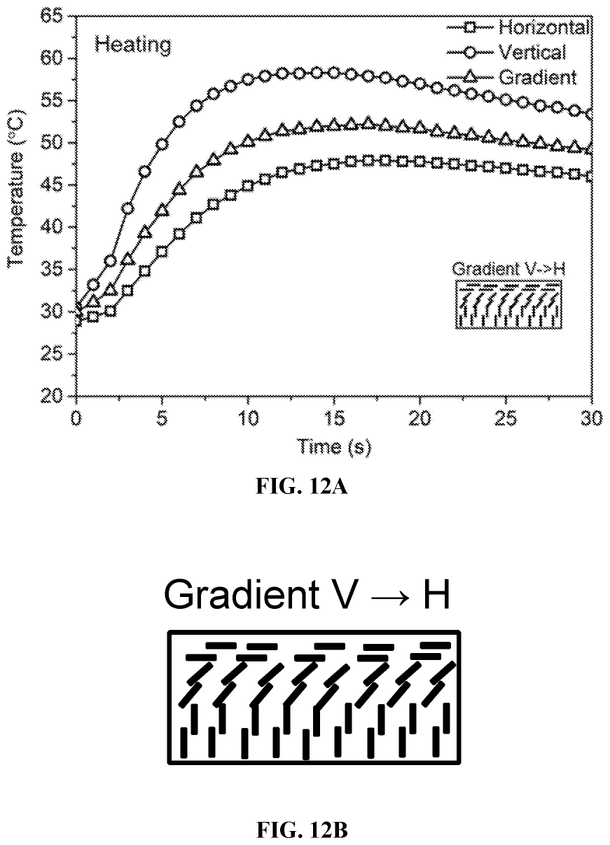

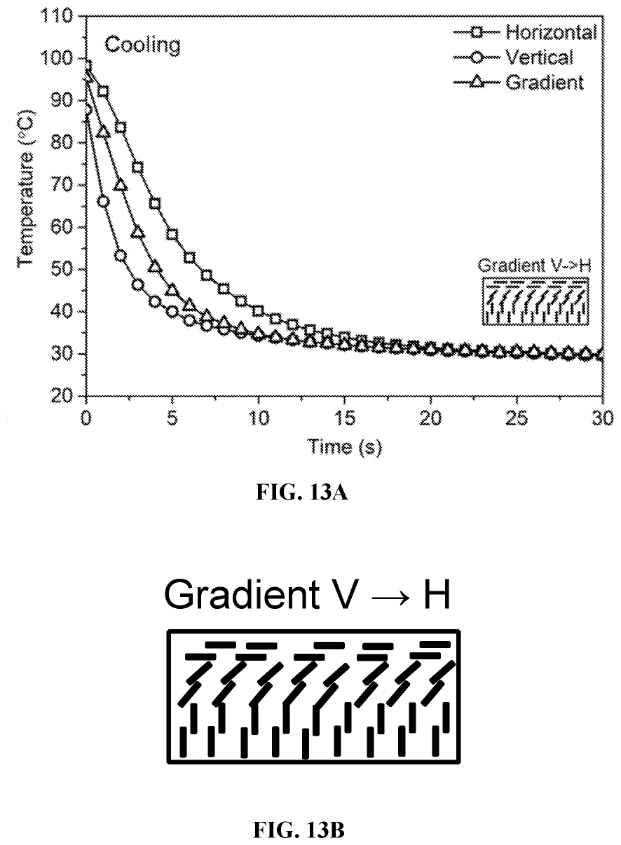

The microstructures of the present article 100 or the composite 103 may be described as including complex oriented angles, i.e., including locally graded or graduated changes in orientations in which the changes in orientations of the microstructures are smaller than 90 degrees. Accumulatively, the complex oriented angles enable a controlled and graded “bending” of the thermal conduction directions in the article 100/composite 103. FIG. 12A shows the rate of heating for three composite samples each configured with different particle orientations. FIG. 12B shows a schematic diagram of the gradient alignment in the sample with complex oriented angles used in the experiments. FIG. 13A shows the rate of cooling for three composite samples each configured with different particle orientations. FIG. 13B shows a schematic diagram of the gradient alignment in the sample with complex oriented angles used in the experiments.

In both situations, the heating rate and the cooling rate of the sample with complex oriented angles perform comparably with the purely axially oriented samples and the purely transversely oriented samples. The experiments therefore verify the practicality and utility of providing graded microstructures (gradient change in the orientation of the particles in the composite).

In addition to their thermal properties, the composites also exhibit considerable mechanical properties which make them practical choices for forming components. The mechanical properties of composites (based on aligned hBN flakes and PVP) are summarized in Table 1 below. The composite samples have a hardness of 0.5 kgf·mm⁻², and 0.7 kgf·mm⁻², for the composited with horizontally (transversely) aligned hBN flakes and vertically (axially) aligned hBN flakes, respectively. The samples with axially aligned hBN flakes display a modulus of 442.3 MPa and a strength of 2.0 MPa.

TABLE 1
Mechanical Properties of the Proposed Composite

| | Hardness | Modulus | Strength |
|---|---|---|---|
| Orientation | (kgf · mm⁻²) | (MPa) | (MPa) |
| Vertical (Axial) | 0.7 | 442.3 | 2.0 |
| Horizontal (Transverse) | 0.5 | 86.0 | 0.35 |
| Random | 1.6 | 304.7 | 1.5 |

### Temperature Distribution

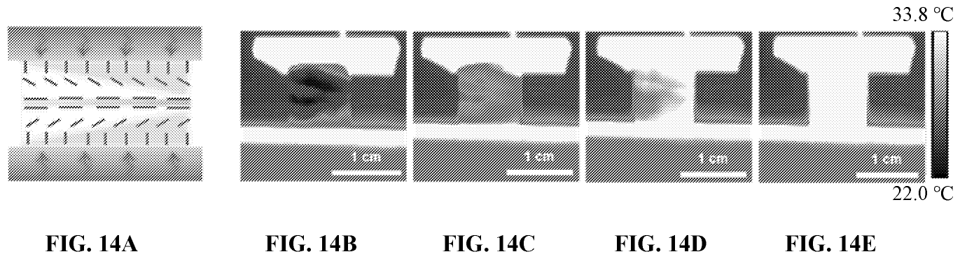

FIG. 14A is a schematic illustration showing the microstructural configuration of a layered composite according to one embodiment of the present disclosure. Heat sources are provided in contact with the top surface and the bottom surface of the layered composite. The shaded areas show that heat is conducted rapidly away from the top surface and the bottom surface through the axially aligned layers and into the thickness of the layered composite. The inclined microplatelet orientation would channel the heat to one side (in this example, to the right side). The transversely oriented layer in the middle will prevent heat from being transferred through the entire thickness of the layered composite. The effect of the transversely oriented layer also includes formation of a heat transfer channel across the middle of the layered composite. The net effect is directed thermal conduction of heat from the top surface and the bottom surface to one side (non-opposing surface relative to the top surface and/or bottom surface) of the layered composite. This opens up many new possibilities for directed thermal conduction. Examples include but are not limited to the possibility of configuring variously inclined rapid thermal conduction paths for heat transfer to selected zones in the composite.

FIGS. 14B to 14E are infrared images taken of a side view of the layered composite of FIG. 14A, showing the directional and inclined (gradient) heat transfers when both the top surface and the bottom surface are in contact with heat sources. The white color (or a lighter shade) indicates a higher temperature, and the dark grey color (or a darker shade) indicates a lower temperature. Immediately after contacting the heat sources, the temperature in the axially aligned layers increases. Slightly inclined temperature slopes can also be seen in the temperature profile in FIG. 14B. In FIG. 14B and FIG. 14C, a higher temperature zone is visible in the middle of the layered composite where the hBN flakes are transversely aligned. This is similar to simulation results obtained. With time, the layered composite heated up and the directed heat conduction through the inclined temperature slopes become more visible, with a symmetrical high-temperature pattern forming in a “V” shape (FIG. 14D). The final and substantially uniform temperature profile is shown in FIG. 14E. If a heat sink were to be placed on the right side of the layered composite, the heat would have been conducted away, preventing heat accumulation in the composite.

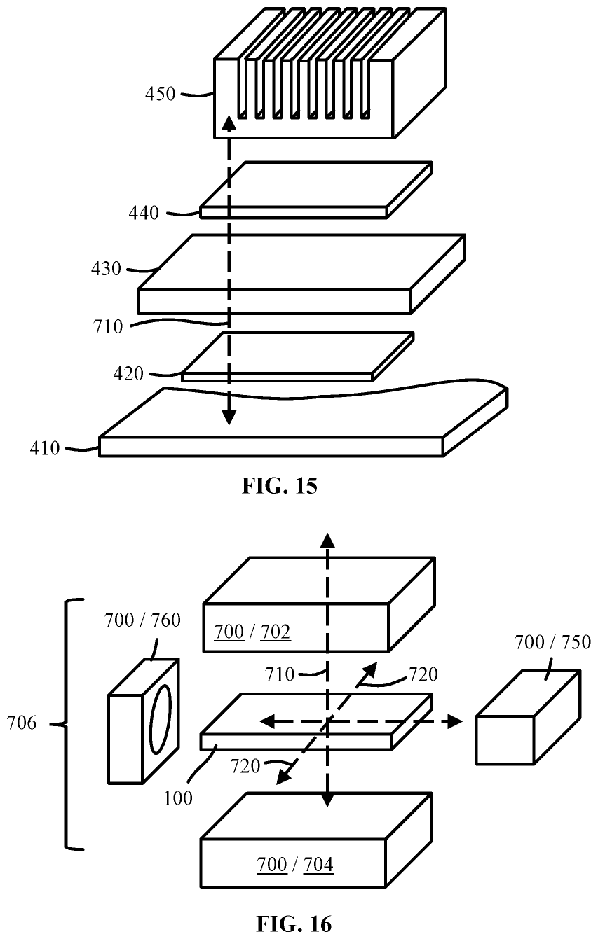

As can be understood from the foregoing, embodiments of the article 100 can advantageously facilitate higher density packaging. To illustrate current challenges of stacked packaging, FIG. 15 shows a schematic diagram of an exploded view of various components. In this illustration, components 430, 450 are stacked along a stack axis 710. Conventional thermal interface materials (TIMs) 420 may be provided at one surface of the component 430 to draw heat away from the component 430 along the stack axis towards a substrate 410. Providing conventional TIMs 440 between the components 430 and 450 could however lead to overheating as heat will be transferred along the stack axis 710 such that heat is spread between the components 430 and 450. Therefore, conventionally, component 450 is a heat sink. As can be appreciated, while stacked packaging is one way to increase electronic packaging density to meet the increasing demand for better performance in ever shrinking form factors, there are practical considerations constraining the type and number of components that can be stacked together. Certain components such as heat sinks will also add substantially to the overall height of the stack.

FIG. 16 schematically illustrates an improved alternative thermal interface component making use of the present article 100 made of the proposed composite 103. The total height 706 of the assembly of components 700 can be reduced without compromising the performance since a thick heat sink (450 of FIG. 15) is no longer required. Heat sensitive components 702 and 704 can be stacked along the stack axis 710 without fear that cross transfers of heat between these components will lead to damage or lowered performance. More choices for heat transfer management components such as fans 760 and heat sinks 750 can be arranged to the side for an overall low profile to facilitate thinner products. This is possible because of the directed thermal conduction enabled by the article 100, such that heat can be transferred inward along axial directions (along the stack axis 710) from components 702/704 and then transferred outward along one or more transverse directions 720. In other words, the article 100 provides for multi-directional thermal conduction.

1. An article, comprising:
a composite, the composite including a polymeric binder and particles in the polymeric binder, the particles being magnetically responsive and having a flake-like geometry, the particles including a thermally anisotropic material such that the particles are characterized by a higher in-plane thermal conductivity and a lower through-plane conductivity,
wherein the composite is characterized by at least one preferred thermal conduction path defined in sections of differently oriented alignments of the particles,
and wherein at least two of the sections are differently oriented relative to one another by a gradient angular difference such that the at least two of the sections are non-parallel and non-perpendicular to one another.

2. The article as recited in claim 1, wherein the at least one preferred thermal conduction path is defined in the composite from a first surface of the article to a second surface of the article, the second surface being a non-opposing surface relative to the first surface.

3. The article as recited in claim 1, wherein the preferred thermal conduction path is determined by locally graduated orientation changes of the particles, and wherein each of the locally graduated orientation changes is smaller than 90 degrees.

4. The article as recited in claim 3, wherein the locally graduated changes provide the preferred thermal conduction path with an accumulative orientation change of 90 degrees.

5. The article as recited in claim 1, wherein a first plurality of the particles and the second plurality of the particles in immediately adjacent regions respectively define successive ones of the sections of the preferred thermal conduction path.

6. The article as recited in claim 5, wherein the first plurality of the particles are aligned with one another, and wherein the second plurality of the particles are aligned with one another.

7. The article as recited in claim 5, wherein the first plurality of the particles and the second plurality of particles correspond to respective layers of the composite.

8. The article as recited in claim 7, wherein the composite is an integral unit formed of layers, and wherein the particles are similarly aligned in each of the layers, and wherein successive ones of the layers are differently oriented by an angular difference smaller than 90 degrees.

9. The article as recited in claim 7, wherein the composite comprises:
a first of the layers in which the particles are aligned along an axial direction;
a final of the layers in which the particles are aligned along a transverse direction, the transverse direction being oriented transversely relative to the axial direction; and
one or more intermediate ones of the layers disposed between the first of the layers and the final of the layers, wherein the at least one preferred thermal conduction path extending in the composite from the first of the layers to the final of the layers exhibit a graded change in orientation from the axial direction to the transverse direction.

10. The article as recited in claim 7, wherein the composite comprises:
a first of the layers in which the particles are aligned along an axial direction;
a final of the layers in which the particles are aligned along the axial direction; and
one or more intermediate ones of the layers disposed between the first of the layers and the final of the layers, wherein the at least one preferred thermal conduction path extending in the composite from the first of the layers to the final of the layers exhibit a graded change in orientation from the axial direction to the transverse direction, wherein the particles of at least one of the one or more intermediate ones of the layers are aligned along a transverse direction, in which the transverse direction is transversely oriented relative to the axial direction.

11. The article as recited in claim 1, wherein the particles are hexagonal boron nitride with superparamagnetic iron oxide nanoparticles adsorbed thereon, and wherein the polymeric binder includes polyvinyl pyrrolidone.

12. The article as recited in claim 11, wherein the composite is characterised by a density of 1.3 g/cm³, and wherein the composite comprises 62.6 vol % hexagonal boron nitride.

13. The article as recited in claim 11, wherein the composite is characterized by a thermal conductivity of 12 W/mK over a range of temperature from at least 25° C. to 200° C. along the at least one preferred thermal conduction path.

14. The article as recited in claim 11, wherein the composite is characterized by an electrical resistivity of at least 25 MΩ·cm.

15. The article as recited in claim 1, wherein the article is configured as a thermal interface component.

16. A method of making the article of claim 1, the method comprising:
forming a plurality of layers on one another, in which each of the plurality of layers is formed by:
depositing a slurry as deposited materials, the slurry being an aqueous suspension of particles and polyvinyl pyrrolidone, the particles being hexagonal boron nitride flakes functionalized to be magnetically responsive;
aligning the particles solely by providing a rotating external magnetic field to the deposited materials; and
unaided drying of the deposited materials on a porous substrate under ambient conditions to form a composite of hexagonal boron nitride and polyvinyl pyrrolidone,
wherein the composite is characterized by at least one preferred thermal conduction path defined in sections of differently oriented alignments of the particles,
and wherein two of the sections are defined respectively in adjacent ones of the plurality of layers,
such the two of the sections are non-parallel and non-perpendicular to one another.

17. The method as recited in claim 16, wherein the method comprises:
forming a first layer of the plurality of layers in which the particles are aligned along an axial direction;
forming a final layer of the plurality of layers in which the particles are aligned along a transverse direction, the transverse direction being oriented transversely relative to the axial direction; and
forming one or more intermediate layers of the plurality of layers disposed between the first layer and the final layer, wherein the at least one preferred thermal conduction path extends in the composite from the first layer to the final layer,
and wherein the at least one preferred thermal conduction path exhibits a graded change in orientation from the axial direction to the transverse direction.

18. The method as recited in claim 16, wherein the method comprises:
forming a first layer of the plurality of layers in which the particles are aligned along an axial direction;
forming a final layer of the plurality of layers in which the particles are aligned along the axial direction; and
forming one or more intermediate layers of the plurality of layers disposed between the first layer and the final layer, wherein the at least one preferred thermal conduction path extending in the composite from the first layer to the final layer exhibits a graded change in orientation from the axial direction to the transverse direction, wherein the particles of at least one of the one or more intermediate layers are aligned along a transverse direction, in which the transverse direction is transversely oriented relative to the axial direction.

19. The method as recited in claim 16, wherein the slurry is characterised by 40 wt % of the particles.

20. The method as recited in claim 16, wherein the composite is characterised by 62.6 vol % of the particles.
